(19) United States
(12) Patent Application Publication
(10) Pub. No.: US 2019/0226538 A1
(43) Pub. Date: Jul. 25, 2019

(54) LONG-STRAND CARBON COMPOSITE BRAKE HOUSING

(71) Applicant: Meggitt Aircraft Braking Systems Corporation, Akron, OH (US)

(72) Inventors: Robert Thomas Dirgo, Cuyahoga Falls, OH (US); Kurt Burkhalter, Akron, OH (US); Kyle J. Hamblin, Akron, OH (US)

(21) Appl. No.: 16/327,965

(22) PCT Filed: Aug. 30, 2017
(86) PCT No.: PCT/US17/49273

§ 371 Date: Feb. 25, 2019

Related U.S. Application Data
(60) Provisional application No. 62/381,772, filed on Aug. 31, 2016.

(51) Int. Cl. F16D 65/00

(52) U.S. Cl. CPC F16D 65/0056; F16D 55/36; F16D 2200/003; F16D 2200/0056

(57) ABSTRACT

A long-strand carbon composite brake housing for use on aircraft is formed from a thermoplastic material carrying long-strand carbon fibers, with the composition, concentration, and orientation of the fibers being such as to optimize the strength of the resultant carrier plate, and particularly in regions subject to high stress and the like. A hydroforming technique accommodates the appropriate positioning of the thermoplastic carbon composition in the desired regions of varying concentrations, compositions, and orientations to achieve a carrier plate for aircraft brake assemblies that is lightweight while being reliable and durable in use.

### CROSS-REFERENCE TO RELATED APPLICATION

This application is a non-provisional utility patent application claiming the benefit of U.S. provisional patent application No. 62/381,772, filed Aug. 31, 2016, for “Long-Strand Carbon Composite Brake Housing.”

### TECHNICAL FIELD

The invention herein resides in the art of vehicle brakes and, more particularly, to aircraft brakes. Specifically, the invention relates to aircraft brakes exhibiting reduced weight by the implementation of a brake housing or carrier plate of a lightweight composite material. More specifically, the invention relates to a process for devising a composite structural member for aircraft brakes that is formed as a long-strand carbon composite, thus reducing the weight of the carrier plate or brake housing without compromising its functionality.

### BACKGROUND OF THE INVENTION

It is well known that aircraft brakes typically comprise a plurality of alternatingly interleaved rotor and stator discs that are respectively operatively connected to a wheel and its axle through torque tubes and the like. This brake disc stack is operated upon by a series of pistons, hydraulically or motor driven, that urge a pressure plate into forceful engagement with the stack, causing frictional engagement between the rotor and stator discs, thus converting mechanical energy into thermal energy and thereby stopping the aircraft.

In typical aircraft brake assemblies, the piston assemblies react against a carrier plate or brake housing during the braking operation and a torque take-out lug or the like is interposed between the carrier plate and landing gear to transfer the brake torque from the wheel to the associated landing gear. Consequently, the carrier plate is subject to high-stress areas where large moments are effected by the braking torque or application of loads through the pistons. Additionally, the carrier plate is subjected to possible deflections and distortions for which a correction or compensation must be made to achieve an effectively responsive brake assembly. This is particularly true in the case of electric brake applications, where a series of motor-driven pistons effect application and release of brake force.

Of course, in aircraft applications, weight is always a consideration since weight in aircraft structures reduces the payload that can be carried and/or increases the costs of operation. Presently, aluminum carrier plates or brake housings are employed. They have been found generally to be lightweight, while being capable of being configured for the necessary strength and resistance to fatigue, fracture, distortion, and deflection.

While aluminum is lightweight, still lighter brake housings or carrier plates are desired and, according to the instant invention, are possible.

### SUMMARY OF THE INVENTION

In light of the foregoing, it is a first aspect of the invention to provide a brake housing or carrier plate of a carbon composite material.

A further aspect of the invention is to provide a brake housing or carrier plate that is lighter weight than corresponding aluminum assemblies, but without sacrificing structural integrity or performance.

Still a further aspect of the invention is to provide a brake housing or carrier plate of the foregoing nature, which is given to ease of manufacture through hydroforming.

Still an additional aspect of the invention is the provision of a brake housing or carrier plate formed as a long-strand carbon composite.

Yet a further aspect of the invention is the provision of a brake housing or carrier plate in the nature of a long-strand carbon-carbon composite that is tailored to the needs of specific regions of the carrier plate or brake housing.

The foregoing and other aspects of the invention are achieved by a vehicle brake housing comprising a structure of a carbon-filled thermoplastic elastomer defining the brake housing and characterized by regions subjected to high stress during braking operations.

In a first embodiment, the present invention provides a vehicle brake housing, comprising: a structure of carbon-filled thermoplastic elastomer defining the brake housing and characterized by regions subjected to high stress during braking operations; and wherein said carbon-filled thermoplastic elastomer is of a substantially uniform distribution of carbon fibers other than in said regions subjected to high stress during braking operations and in which a composition, concentration, orientation and nature of said carbon fibers is tailored to accommodate anticipated high stresses.

A second embodiment provides a vehicle brake housing as in any embodiment above, wherein said regions subjected to high stress during braking operations comprise areas characterized by bolt holes, brake cylinder receivers, and torque take-out lugs.

A third embodiment provides a vehicle brake housing as in any embodiment above, wherein said carbon-filled thermoplastic elastomer comprises long-strand carbon fibers having a length greater than 0.5 inch.

A fourth embodiment provides a vehicle brake housing as in any embodiment above, wherein said structure is formed by a process taken from the group of hydroforming and cast-over forming.

A fifth embodiment provides a vehicle brake housing as in any embodiment above, wherein said structure is formed over an underlayment.

A sixth embodiment provides a vehicle brake housing as in arty embodiment above, wherein said underlayment comprises a preform of said structure.

A seventh embodiment provides a vehicle brake housing as in arty embodiment above, wherein said preform is made of a material taken from the group of carbon-filled thermoplastic elastomer and aluminum.

Art eighth embodiment provides a vehicle brake housing as in arty embodiment above, wherein said structure is formed over a spider.

### BRIEF DESCRIPTION OF THE DRAWINGS

For an understanding of the various aspects and features of the invention, reference should be made to the following detailed description and accompanying drawings wherein:

FIG. 1 is a top plan view of an aircraft wheel and brake assembly made in accordance with the invention;

FIG. 2 is a cross-sectional view of the aircraft wheel and brake assembly as shown in FIG. 1, taken along the line 2-2;

FIG. 3 is a cross-sectional view of the generalized structure of a preform contemplated as a portion of the invention; and

FIG. 4 is a top plan view of a spider contemplated as a possible base structure for the generation of a brake housing or carrier plate according to the invention.

### DETAILED DESCRIPTION OF PREFERRED EMBODIMENT

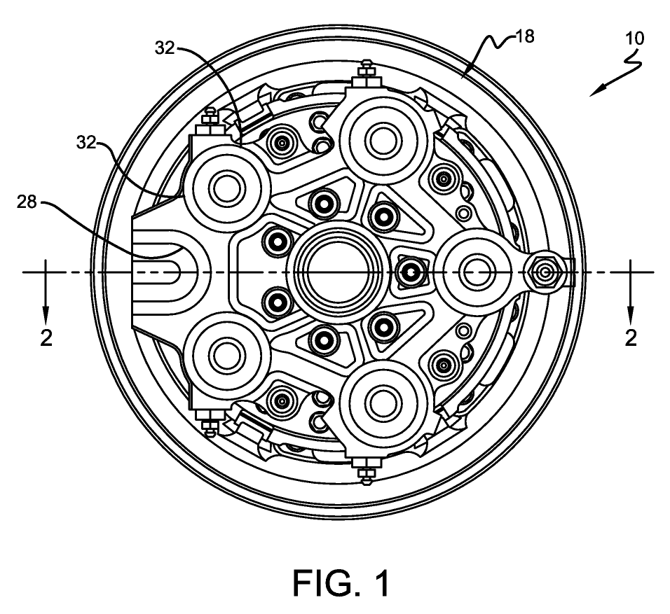

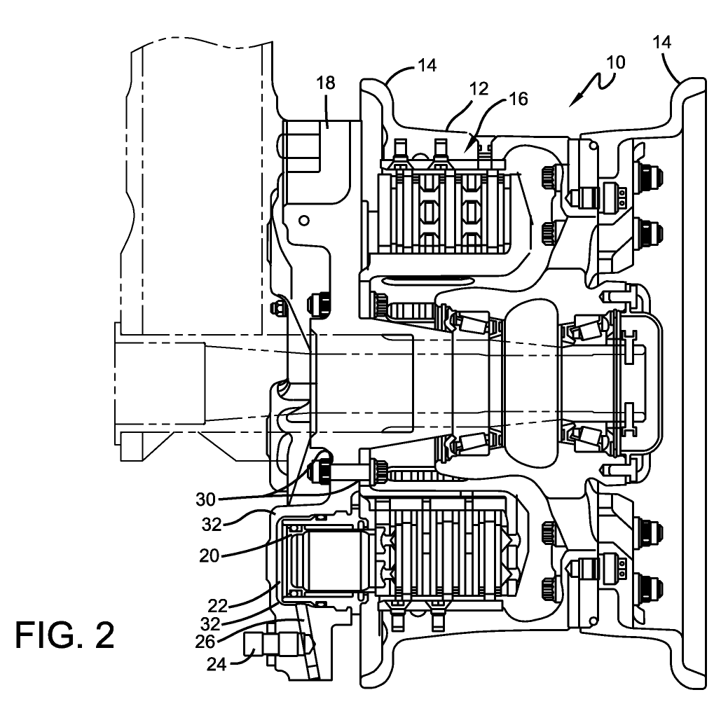

With reference now to the drawings, and more particularly FIGS. 1 and 2, it can be seen that an aircraft wheel and brake assembly made in accordance with the invention is designated generally by the numeral 10. The assembly 10 includes a wheel 12 with separated mounting and sealing flanges 14 for receiving art appropriate pneumatic tire or the like.

Received within the wheel 12 is a heat stack 16 of alternatingly interleaved rotors and stators sandwiched between a pressure plate and an endplate, all of which is rather typical in the aircraft braking art.

A carrier plate or brake housing 18 encloses one end of the wheel and brake assembly 10 and is configured with receivers to receive hydraulic piston assemblies 20, in the case of hydraulic brake systems. For use in association with electric brake systems, an electric motor with drive gears and associated pistons would replace the hydraulic piston assemblies 20. In either event, a cylinder 22 is provided for receipt of the hydraulic piston assemblies, motor/drive mechanism arrangement, as shown. When hydraulic brakes are employed, a hydraulic coupling 24 and hydraulic fluid passages 26 are also employed for communicating with the cylinder 22 to generate the pressure necessary for driving the hydraulic piston 20. In the case of electric brakes, no such passages are required through the carrier plate 18.

As will be appreciated by those skilled in the art, when the electric motor or hydraulic piston is actuated for braking activity, the elements of the heat stack are placed into forceful engagement with the rotors and stators being urged into frictional engagement between an appropriate pressure plate and endplate. This forceful engagement and ensuing braking torque results in high stresses and moments being generated in the carrier plate or brake housing 18.

According to the invention, carrier plates and brake housings for aircraft may be manufactured using carbon composite materials through a hydroforming process. Typically, a thermoplastic material with carbon fiber fillers is contemplated for use. Most preferably, the invention contemplates employment of long-strand carbon fibers having a length on the order of 0.5-1.0 inch or more. It has been found that the strength of the resultant composite is, to a large extent, dependent upon the fiber orientation within the composite. Accordingly, it is contemplated that, through the hydroforming process, fiber composition, concentration, orientation, and length will all be selected to maximize the strength and rigidity necessary to minimize the stresses, strains, distortions and deflections that otherwise might be attendant to the carrier plate or brake housing during braking operations. In that regard, those skilled in the art will appreciate that aircraft brake carrier plates are characterized by a plurality of flanges, ribs, raised and recessed areas, and other geometric variations, which should be addressed with regard to composition, concentration, orientation, and fiber length of the carbon-filled thermoplastic elastomer.

With reference again to FIGS. 1 and 2, regions of particular interest for an aircraft brake carrier plate may be seen. For instance, in the region designated by the numeral 28, a torque take-out lug that is connected to the landing gear will engage the carrier plate 18. In this curvate region 28, high stress levels are imparted during braking operation since the torque stopping the braked wheel passes therethrough to the torque take-out lug and thence to the landing gear. Accordingly, compositions, concentrations, and fiber orientation must be addressed in this region to maximize the resisting strength.

High-stress regions are also characteristic of the bolt-hole areas 30 circling the center of the carrier plate 18, as well as the regions 32 about the cylinders 22.

In all of the high-stress regions of the carrier plate 18, consideration must be given to tailoring the composition, concentration, orientation and nature of the carbon fiber fill employed in the thermoplastic elastomer. Through the use of hydroforming, these parameters can be addressed to ensure optimum performance by reduced distortion and deflection while enhancing strength and rigidity to accommodate a long and effective wear life. While various regions of the carrier plate 18 may be characterized by a substantially homogeneous or uniform distribution of carbon fibers of a desired diameter, length, and orientation, other regions, such as the high-stress regions presented by way of example above, will typically require specific attention to optimize performance and utility.

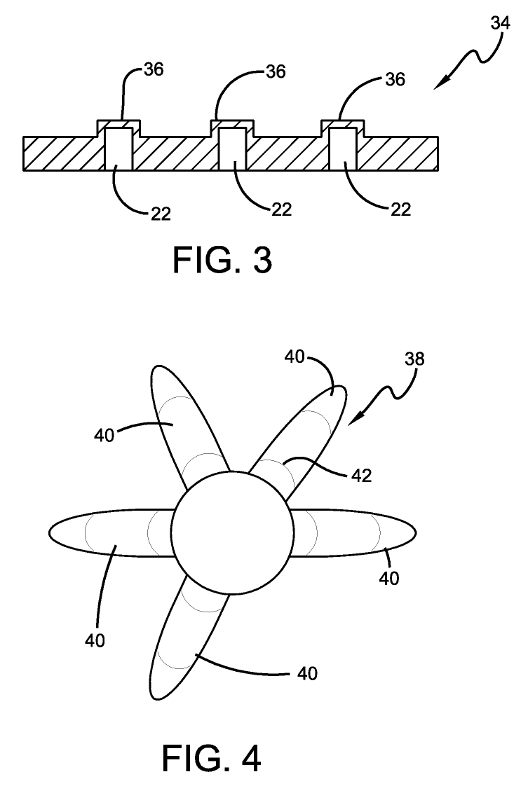

The invention also contemplates that the carrier plate or brake housing 18 may also be formed using a cast-over or hydroforming technique over an underlayment of sorts. With reference to FIG. 3, the invention contemplates employment of a preform having the general geometric configuration of the carrier plate 18 over which can be formed the final configuration. As shown in FIG. 3, the underlayment may be of the nature of a preform 34, shown in cross-section, and includes raised portions 36 that might typically accommodate the cylinders 22. The preform can be made of any of various types of material, including a carbon-filled thermoplastic elastomer. It may, however, be made of a lightweight material demonstrating strength and rigidity, such as aluminum or the like. Of course, the preform 34 is most desirably of a strong, lightweight material, and to which a thermoplastic material may readily bond.

The invention further contemplates that a spider base 38, as shown in FIG. 4, might be employed for the basic structural integrity of the carrier plate 18 and as an underlayment for receipt of the carbon-filled thermoplastic elastomer forming the brake housing itself. The spider 38 has multiple legs 40 radiating from a central region and may be characterized by braces, struts, or support members 42 for purposes of rigidity and for providing bonding surfaces for the thermoplastic elastomer. Preferably, the spider 38 is a high-strength material that is lightweight and which provides an underlying strength for the carrier plate 18, as a whole.

Thus it can be seen that the various aspects of the invention can be achieved by the structure and methodology discussed above. The ultimate scope and breadth of the invention will be determined by claims attendant to any conversion of this provisional application to a non-provisional application.

What is claimed is:

1. A vehicle brake housing, comprising:
a structure of carbon-filled thermoplastic elastomer defining the brake housing and characterized by regions subjected to high stress during braking operations; and
wherein said carbon-filled thermoplastic elastomer is of a substantially uniform distribution of carbon fibers other than in said regions subjected to high stress during braking operations and in which a composition, concentration, orientation and nature of said carbon fibers is tailored to accommodate anticipated high stresses.

2. The vehicle brake housing according to claim 1, wherein said regions subjected to high stress during braking operations comprise areas characterized by bolt holes, brake cylinder receivers, and torque take-out lugs.

3. The vehicle brake housing according to claim 2, wherein said carbon-filled thermoplastic elastomer comprises long-strand carbon fibers having a length greater than 0.5 inch.

4. The vehicle brake housing according to claim 3, wherein said structure is formed by a process taken from the group of hydroforming and cast-over forming.

5. The vehicle brake housing according to claim 4, wherein said structure is formed over an underlayment.

6. The vehicle brake housing according to claim 5, wherein said underlayment comprises a preform of said structure.

7. The vehicle brake housing according to claim 6, wherein said preform is made of a material taken from the group of carbon-filled thermoplastic elastomer and aluminum.

8. The vehicle brake housing according to claim 4, wherein said structure is formed over a spider.
